(19) United States
(12) Patent Application Publication
(10) Pub. No.: US 2006/0266983 A1
(43) Pub. Date: Nov. 30, 2006

(54) Inhibitor particles, method of production of same, electrode paste, method of production of electronic device

(75) Inventors: Kazutaka Suzuki, Narita-shi (JP); Shigeki Sato, Narita City (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/407,265

(22) Filed: Apr. 20, 2006

(30) Foreign Application Priority Data
Apr. 21, 2005 (JP) 2005-124041
Mar. 6, 2006 (JP) 2006-059954

(51) Int. Cl. H01B 1/12

(52) U.S. Cl. 252/500

(57) ABSTRACT

Inhibitor particles, contained in an electrode paste for forming electrodes so as to suppress spheroidization of conductive particles contained in the electrode paste in a firing process, each particle having a core part formed by a dielectric particle and a covering layer covering around the core part, the covering layer formed by a precious metal. The precious metal is comprised of a metal or alloy having at least one element selected from ruthenium (Ru), rhodium (Rh), rhenium (Re), platinum (Pt), iridium (Ir), and osmium (Os) as a main ingredient.

### BACKGROUND OF THE INVENTION

1. Field of the Invention

The present invention relates to inhibitor particles included together with conductive particles in an electrode paste used when producing an electronic device having dielectric layers and internal electrode layers, a method of production of those inhibitor particles, an electrode paste in which the inhibitor particles are included, and a method of production of a multilayer ceramic capacitor or other electronic device using the electrode paste.

Particularly, the present invention relates to inhibitor particles included in an internal electrode use electrode paste suitable for forming internal electrodes of for example a large capacitance multiplayer ceramic capacitor having dielectric layers and internal electrode layers of small thicknesses and a large number of stacked internal electrode layers.

2. Description of the Related Art

In recent years, multilayer ceramic capacitors are becoming smaller in size and larger in capacitance. Along with this, methods for stacking dielectric layers and internal electrode layers thinner and with less defects have become considered necessary.

Ni electrodes used as internal electrodes are lower in melting point compared with the dielectric material and have a large difference in sintering temperature from the dielectric material, so during firing in a reducing atmosphere, the internal electrodes become spheroidal due to particle growth and spaces are formed between the adjoining nickel particles. For this reason, continuous internal electrodes become difficult to form. In the case of a multilayer ceramic capacitor, there was therefore the problem of the electrostatic capacitance dropping.

To solve these problems, up to now, the technique has been used of adding to the electrode paste dielectric particles of a composition the same as the dielectric layers as inhibitor particles. By including these inhibitor particles in the electrode paste together with the Ni particles, it is possible to suppress spheroidization of the Ni due to particle growth to a certain degree. These inhibitor particles may be obtained by uniformly mixing and crushing a dielectric powder and additive material by a ball mill etc.

However, this technique is effective in a region of Ni electrode thickness of 1.0 μm or more, but when the layers become thinner and reach a region of 1.0 μm or less, with just the effect of addition of the inhibitor particles, it is not possible to suppress the spheroidization of Ni due to particle growth. As a result, continuous internal electrodes become difficult to form and the capacitor is reduced in capacitance characteristic.

Note that the fact that when making the internal electrodes thinner, use of a conductive ingredient comprised of an alloy of Ni and a precious metal is effective against the above problem was clarified by the inventors. That is, use of for example a powder of an alloy of Ni and Pt as the conductive particles included in the internal electrode paste has been proposed. Further, in addition, they learned that even Ni powder covered by a Pt coating is similarly effective for reduction of the thickness of the internal electrodes and filed a patent application for it (see Japanese Patent Application No. 2004-36417).

However, when trying to form a Pt coating around Ni particles by adding Ni powder to a Pt chloride aqueous solution and adding a reducing agent while stirring to make Pt particles precipitate by reduction on the surfaces of the Ni particles, there is the problem that segregated particles of Pt of several μm or more size are formed from the Pt chloride aqueous solution and the Ni powder is not coated by the Pt.

### SUMMARY OF THE INVENTION

The present invention has been made in view of this situation and has its object to provide inhibitor particles able to suppress particle growth of Ni particles in the firing stage even if the internal electrode layers are made smaller in thickness and to effectively prevent spheroidization, electrode disconnection, and a drop in the electrostatic capacitance.

Further, another object of the present invention is to provide a method of production of inhibitor particles able to produce inhibitor particles with good precious metal coverage without forming segregated particles of precious metal when producing the inhibitor particles.

A further object of the present invention is to provide an electrode paste including the inhibitor particles and a method of production of a multilayer ceramic capacitor or other electronic device having internal electrode layers formed thinly using the electrode paste.

The inventors engaged in experiments regarding electrode paste including conductive particles of Ni/Pt alloy and as a result discovered that making the inhibitor particles included in the internal electrode use electrode paste a dielectric powder covered by a Pt or other precious metal is effective for reducing the thickness of the internal electrode layers and enabled them to achieve the objects of the present invention.

That is, the inhibitor particles according to the present invention are inhibitor particles included in the electrode paste so as to suppress spheroidization of the conductive particles included in the electrode paste for forming the electrodes during the firing process, each having a core part formed by dielectric particles and a covering layer covering around the core part, the covering layer being formed by a precious metal.

Preferably, the precious metal is comprised of a metal or alloy having at least one element selected from ruthenium (Ru), rhodium (Rh), rhenium (Re), platinum (Pt), iridium (Ir), and osmium (Os) as a main ingredient. More preferably, the precious metal is comprised of a metal or alloy having at least one type of element selected from ruthenium (Ru), rhodium (Rh), rhenium (Re), and platinum (Pt) as a main ingredient.

The core parts may be covered by the covering layers continuously or covered by them discontinuously.

Preferably, the core parts have a particle size of 10 nm to 100 nm. Preferably, the covering layers have a thickness of 1 to 15 nm, more preferably 1 to 10 nm in range, particularly preferably 1 to 8 nm in range. If the covering layers are too small in thickness, the present invention tends to become smaller in action and effect. Further, if the covering layers are too large in thickness, the Ni particles and inhibitor particles in the paste become poor in dispersion ability. After printing, the coating density ρg and flatness become poor. As a result, electrode disconnection tends to increase. Further, the dielectric loss tans also tends to increase. Preferably, when the particles in the core parts have a particle size of d0 and the covering layers have a thickness of t0, 0<t0/d0≦0.3.

Note that in the present invention, the particle size of particles means the diameter when the particles are spherical and means the maximum length in the shape of the particles when they are other shapes.

The electrode paste according to the present invention has inhibitor particles, conductive particles, a solvent, a binder resin, and a dispersant. The conductive particles are nickel metal particles or nickel-containing alloy particles or other base metal particles.

Preferably, when the metal ingredient included in the electrode paste as a whole is 100 mol %, the content of the precious metal ingredient for forming the covering layers is larger than 0 mol % to 20 mol %, more preferably 1 to 19 mol %, particularly preferably 1 to 15 mol %.

The method of production of an electronic device according to the present invention is a method of production of an electronic device having internal electrode layers and dielectric layers, comprising a step of using the above electrode paste to form electrode pattern films forming the internal electrode layers, a step of stacking such electrode pattern films with green sheets forming dielectric layers after firing, and a step of firing the stack of the green sheets and the electrode pattern films.

Note that the green sheet able to be used in the present invention is not particularly limited in material and method of production. It may be a ceramic green sheet formed by the doctor blade method, a porous ceramic green sheet obtained by two-dimensional drawing of an extruded film, etc.

The precious metal forming the covering layers of the inhibitor particles is a precious metal having a melting point higher than the Ni or other base metal forming the conductive particles included in the electrode paste. In the firing process, the covering layers of the inhibitor particles are believed to react with the Ni or other base metal forming the conductive particles included in the electrode paste to form an alloy.

As a result, it is possible to suppress particle growth of the Ni particles or other conductive particles in the firing stage to effectively prevent spheroidization, electrode disconnection, etc. and thereby effectively suppress the drop in electrostatic capacitance. Further, it is possible to prevent delamination between the internal electrode layers and dielectric layers.

Preferably, the dielectric layers are formed by a dielectric material able to be fired in a reducing atmosphere. The internal electrode layers are mainly layers having nickel or another base metal as main ingredients, so it is preferable to prevent oxidation at the time of cofiring by forming the dielectric layers by a dielectric material able to be fired in a reducing atmosphere.

Preferably, the internal electrode layer have a thickness after firing of 1 μm or less, preferably 0.1 to 0.5 μm. In the present invention, when the internal electrode layers have thicknesses made particularly thin, it is possible to suppress spheroidization of the base metal particles and effectively prevent elect-rode disconnection etc.

Preferably, the coverage rate, showing the ratio of the area by which the fired internal electrode layers actually cover the dielectric layers with respect to the ideal design area by which the fired internal electrode layers cover the dielectric layers, is 70% or more, more preferably 80% or more. According to the present invention, the coverage rate can be improved.

The method of production of inhibitor particles according to the present invention has a dispersion preparation step of preparing an aqueous dispersion including a core powder forming the core parts, a water-soluble metal salt including a metal or alloy forming the covering layers, and a surfactant (and/or water-soluble polymer compound) and a reduction-precipitation step of mixing the aqueous dispersion and reducing agent and precipitating by reduction a metal or alloy forming the covering layers on the outside surfaces of the core powder.

The surfactant is not particularly limited, but preferably is a nonionic surfactant. The value of the hydrophilic lipophilic balance value (HLB) is preferably 8 to 20. A nonionic surfactant is preferable since it does not include any metal ingredient forming an impurity. Further, the HLB value is preferably 8 to 20 because a solvent comprised of an aqueous solution is used, so a hydrophilic surfactant is preferably selected.

Further, the surfactant is included, with respect to the water in the aqueous dispersion as 100 parts by weight, in an amount of preferably 0.001 to 1 part by weight. If the surfactant is too small in content, in the reduction-precipitation step, the metal or alloy for forming the covering layers tends to end up abnormally segregating without forming covering layers (segregated particles of several μm or more in size). Further, if the surfactant is too great in content, precipitation of the covering layer metal or alloy on the outside surfaces of the core powder tends to become difficult.

The water-soluble polymer compound is not particularly limited, but preferably is at least one of an acrylic acid ester polymer, a methacrylic acid ester polymer, and a copolymer of an acrylic acid ester and methacrylic acid ester, but the polymer preferably has a molecular weight of 50,000 to 200,000 and an acid value of 3 mgKOH/g to 20 mgKOH/g. These ranges are set because the precious metal particles for the covering layers are improved in dispersion ability and can effectively suppress segregation of the precious metal particles for the covering layers. Note that if the molecular weight is smaller than the above, the dispersion is poor, while if it is large, the aqueous solution becomes thicker and handling becomes difficult. Further, precipitation on the core dielectric particles tends to become difficult. If the acid value is smaller than the above range, the dispersion is poor, while conversely if larger, precipitation on the core dielectric particles tends to become difficult.

Preferably, the water-soluble polymer compound is included, with respect to the water in the aqueous dispersion as 100 parts by weight, in an amount of 0.001 to 1 part by weight. If the water-soluble polymer compound is too small in content, in the reduction-precipitation step, the metal or alloy for forming the covering layers tends to end up abnormally segregating without forming covering layers (segregated particles of several μm or more in size). Further, if the water-soluble polymer compound is too great in content, precipitation of the covering layer metal or alloy on the outside surfaces of the core powder tends to become difficult.

Preferably, the water-soluble polymer compound is a polyvinyl alcohol (PVA). In the case of PVA, partially saponified PVA having a saponification degree of 87 to 89 mol % is preferable. If using PVA having a saponification degree in this range, the solubility with respect to water is improved and the dispersion ability is also improved, so the Pt particles produced form finer particles, the Pt coating layer formed on the surface of the dielectric particles becomes continuous, and a good coated powder is obtained. Further, for improving the dispersion ability, a PVA forming a block structure by the above range of saponification degree is preferable. By making it a block structure, the surface activity becomes larger and the surface tension falls resulting in a larger emulsifying power. That is, the dispersion ability is improved more.

Preferably, the reducing agent is at least one of hydrazine, hypophosphoric acid, and formic acid, particularly preferably is hydrazine. The reducing agent is included, with respect to the water in the aqueous dispersion as 100 parts by weight, in an amount of 0.1 to 10 parts by weight. By treatment under this condition, it is possible to produce the inhibitor particles of the present invention efficiently without causing abnormal segregation.

Preferably, the metal or alloy forming the covering layers is precipitated by reduction on the outside surfaces of the core powder, then the core powder is heat treated at a heat treatment temperature of 200 to 400° C. By heat treatment under this condition, the bonding force of the covering layers on the core parts can be raised. This fact is also experimentally confirmed.

Preferably, the content of the water-soluble metal salt in the aqueous dispersion is, with respect to the water as 100 parts by weight, 0.01 to 1 part by weight. If this content is too small, there is less abnormal segregation of the covering layer metal or alloy, but the efficiency of recovery of the inhibitor particles formed with the covering layers tends to become poorer in proportion to the large amount of water used. Further, if the content is too great, abnormal segregation of the covering layer metal or alloy (segregated particles of several μm size) tend to easily occur.

Preferably, the water-soluble metal salt is at least one of platinum chloride, rhodium chloride, rhenium pentachloride, rhenium trichloride, and ruthenium chloride, particularly preferably is rhenium pentachloride or rhenium trichloride.

In the method of production of the present invention, the covering layers preferably cover the entire circumferences of the outside surfaces of the core parts without any gaps, but do not necessarily have to cover the entire circumferences. The metal or alloy forming the covering layers can be made to precipitate by reduction on the outside surfaces of the core powder so that the covering layers cover just parts of the outside surfaces of the core parts. That is, the layers precipitated by reduction are ideally continuous films uniformly coated on the entire surfaces of the dielectric particles. Even in a state where specific precious metal particles of several to several hundred 15 nm or less size (for example Pt particles) are bonded to the surfaces of the dielectric powder forming the core parts, there is an effect of suppressing spheroidization or coating disconnection.

In the present invention, the electronic device is not particularly limited, but a multilayer ceramic capacitor, piezoelectric device, chip inductor, chip varistor, chip thermistor, chip resistor, or other surface mounted (SMD) chip type electronic device may be mentioned.

Ru, Rh, Re, Pt, Ir, Os, and other precious metals are precious metals having melting points higher than Ni or another base metal. Further, covering layers having precious metals or their alloys as main ingredients are superior in wettability and bondability with the dielectric layers. Therefore, by using an electrode paste including inhibitor particles formed by dielectric particles formed with these covering layers and conductive particles of the base metal to form internal electrode layers, even if the internal electrode layers are made thin, it is possible to suppress particle growth of the Ni particles or other base metal particles at the firing stage. As a result, spheroidization of the base metal particles, electrode disconnection, etc. can be effectively prevented and a drop in the electrostatic capacitance can be effectively suppressed. Further, delamination between the internal electrode layers and dielectric layers etc. can be prevented. Further, there are no firing defects of the dielectric powder.

Further, according to the method of production of the present invention, it is possible to efficiently produce inhibitor particles optimal for use as inhibitor particles included in the electrode paste for forming the internal electrode layers of an electronic device having internal electrode layers and dielectric layers without causing abnormal segregation (segregated particles of several μm size) etc. That is, according to the method of production of the present invention, it is possible to prevent the formation of precious metal (for example Pt) segregated particles of several μm size and form a good Pt or other covering layer on the surface of dielectric particles or other core powder of 100 nm or less size.

In the method of production of the present invention, the action of the water-soluble polymer compound or surfactant is believed to include the action, when using addition of a reducing material to form precious metal (for example Pt) particles, of causing polymer compound molecules or surfactant molecules to be adsorbed on the surface of the precious metal particles to prevent the precious metal particles from directly contacting each other and thereby suppress coagulation or segregation of several μm size.

### BRIEF DESCRIPTION OF THE DRAWINGS

Below, the present invention will be explained based on embodiments shown in the drawings, wherein

FIG. 1 is a schematic cross-sectional view of a multilayer ceramic capacitor according to an embodiment of the present invention,

FIG. 2A and FIG. 2B are schematic cross-sectional views of an inhibitor particle according to an embodiment of the present invention,

FIG. 3 is a cross-sectional view of principal parts of an internal electrode layer shown in FIG. 1, and

FIG. 4A to FIG. 4C and FIG. 5A to FIG. 5C are cross-sectional views of principal parts of a method of transfer of an internal electrode layer film.

### DESCRIPTION OF THE PREFERRED EMBODIMENTS

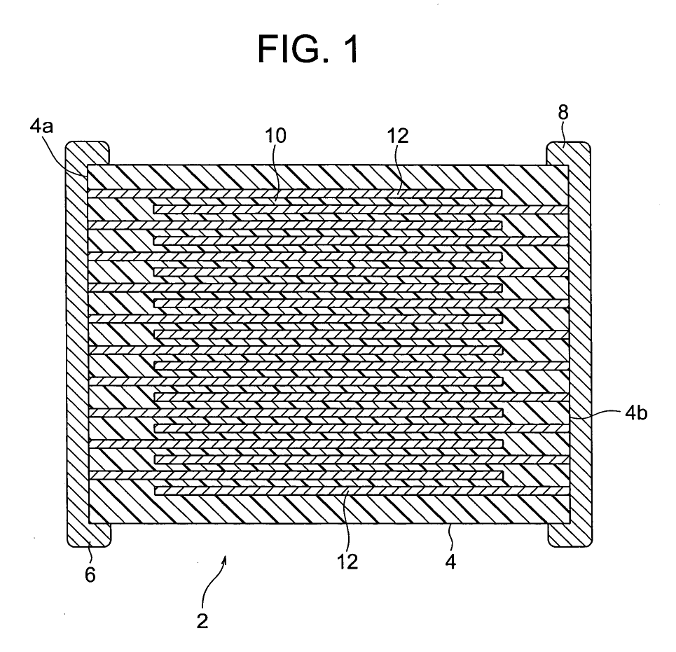

First, the overall configuration of a multilayer ceramic capacitor according to an embodiment of an electronic device according to present invention will be explained. As shown in FIG. 1, the multilayer ceramic capacitor 2 according to the present embodiment has a capacitor body 4, a first terminal electrode 6, and a second terminal electrode 8. The capacitor body 4 has dielectric layers 10 and internal electrode layers 12. The internal electrode layers 12 are stacked alternately projecting to one side and the other between the dielectric layers 10. The alternately stacked internal electrode layers 12 projecting to one side are electrically connected to the inside of the first terminal electrode 6 formed at the outside of the first end 4a of the capacitor body 4. Further, the alternately stacked internal electrode layers 12 projecting to the other side are electrically connected to the inside of the second terminal electrode 8 formed at the outside of the second end 4b of the capacitor body 4.

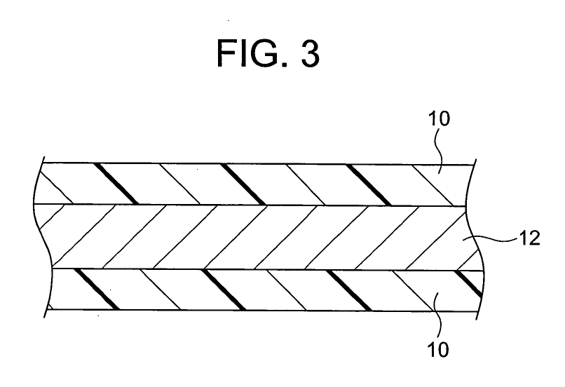

In the present embodiment, the internal electrode layers 12 shown in FIG. 1 and FIG. 3 are electrode layers having the base metal nickel as their main ingredients and further include at least one precious metal selected from ruthenium (Ru), rhodium (Rh), rhenium (Re), platinum (Pt), iridium (Ir), and osmium (Os). In each internal electrode layer 12, the Ni metal and precious metal are considered to be present in the form of an alloy of the same.

The content of the nickel in the internal electrode layers 12 is, with respect to all of the metal included in the internal electrode layers as 100 mol %, 87 mol % to less than 100 mol %. Further, similarly, the content of the precious metal is larger than 0 mol % to 20 mol %, more preferably 1 to 19 mol %, particularly preferably 1 to 15 mol %. If the ratio of the precious metal is too small, the effect of suppressing the particle growth of the Ni particles in the core metal at the firing stage tends to become smaller, while if too great, the cost tends to become higher. As metal ingredients (impurities) which may be included in the internal electrode layers 12, Cu, Co, Fe, Ta, Nb, W, Zr, Au, Pd, etc. may be mentioned.

Note that internal electrode layers may include S, C, P, and other various types of trace ingredients in amounts of 0.1 mol % or so or less.

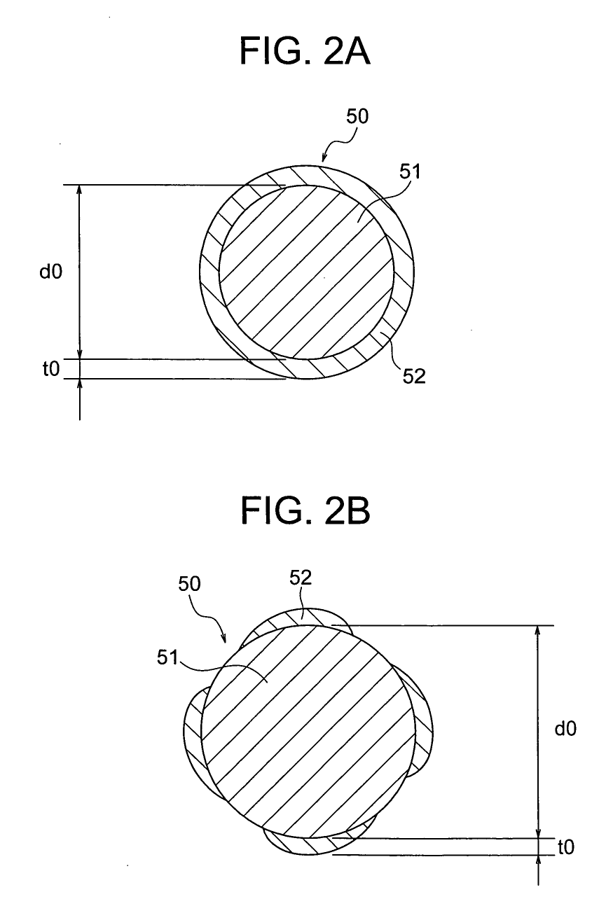

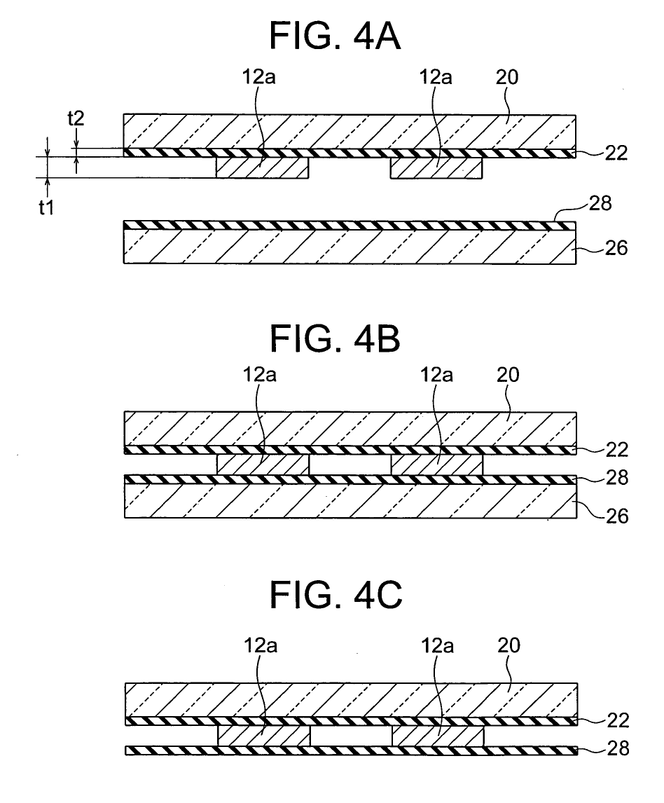

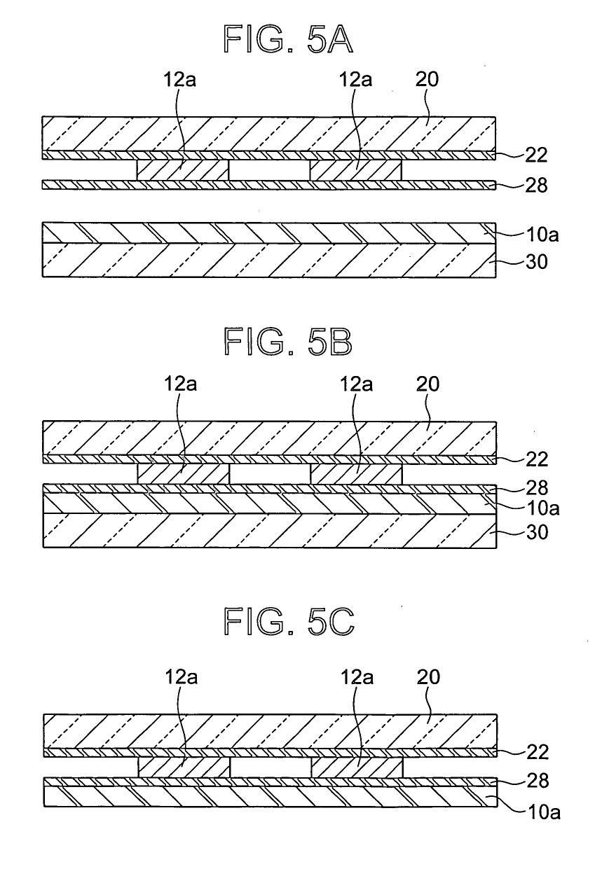

The internal electrode layers 12 shown in FIG. 1 and FIG. 3, as will be explained in detail later, are formed using an electrode paste including inhibitor particles 50 shown in FIG. 2A or FIG. 2B and not shown conductive particles. As shown in FIG. 4A to FIG. 5C, an electrode pattern film 12a is formed by being transferred to a ceramic green sheet 10a. Each internal electrode layer 12 has a thickness greater than that of the electrode pattern film 12a by exactly the amount of shrinkage in the horizontal direction due to firing.

The dielectric layers 10 are not particularly limited in material. For example, they may be comprised of calcium titanate, strontium titanate, and/or barium titanate or another dielectric material. These dielectric layers 10 are preferably comprised of a dielectric material able to be fired in a reducing atmosphere.

Each dielectric layer 10 is not particularly limited in thickness, but a thickness of several μm to several hundred μm is general. Particularly, in the present embodiment, each layer is preferably made a thin 5 μm or less, more preferably 3 μm or less.

The terminal electrodes 6 and 8 are not particularly limited in material, but usually copper or a copper alloy, nickel or a nickel alloy, etc. may be used, but silver or a silver and palladium alloy etc. may also be used. The terminal electrodes 6 and 8 are not particularly limited in thickness, but usually are 10 to 50 μm or so in thickness.

The multilayer ceramic capacitor 2 may be suitably determined in shape and size in accordance with the object or application. When the multilayer ceramic capacitor 2 is a parallelepiped in shape, it is usually a length of (0.6 to 5.6 mm)×width of (0.3 to 5.0 mm)×thickness of (0.1 to 3.2 mm) or so.

Next, an example of the method of production of the multilayer ceramic capacitor 2 will be explained. First, to produce the ceramic green sheets forming the dielectric layers 10 shown in FIG. 1 after firing, a dielectric paste is prepared. The dielectric paste is usually formed by kneading a dielectric material and organic vehicle to obtain an obtained organic solvent-based paste or water-based paste.

The dielectric material may be suitably selected from various types of compounds forming composite oxides or oxides such as carbonates, nitrates, hydroxides, organometallic compounds, etc. and may be mixed for use. The dielectric material usually is used as a powder having an average particles size of 0.1 to 3.0 μm or so. Note that to form extremely thin green sheets, it is preferable to use a powder finer than the thickness of the green sheets.

The organic vehicle is comprised of a binder dissolved in an organic solvent. The binder able to be used in the organic vehicle is not particularly limited, but ethyl cellulose, polyvinyl butyral, an acryl resin, or other usual types of binders may be used. Preferably, polyvinyl butyral or another butyral-based resin is used.

Further, the organic solvent used in the organic vehicle is not particularly limited, but terpineol, butyl carbitol, acetone, toluene, or another organic solvent is used. Further, the vehicle in the aqueous paste is comprised of water in which a water-soluble binder is dissolved. The water-soluble binder is not particularly limited, but polyvinyl alcohol, methyl cellulose, hydroxyethyl cellulose, a water-soluble acryl resin, emulsion, etc. may be used. The contents of the ingredients in the dielectric paste are not particularly limited, the usual contents may be used, for example, the binder in an amount of 1 to 5 wt % or so and the solvent (or water) in an amount of 10 to 50 wt % or so.

The dielectric paste may contain, in accordance with need, additives selected from various types of dispersants, plasticizers, dielectric materials, glass frit, insulators, etc. However, the total content is preferably 10 wt % or less. When using as the binder resin a butyral-based resin, a plasticizer is preferably included in an amount, with respect to the binder resin as 100 parts by weight, of 25 to 100 parts by weight. If the plasticizer is too small in amount, the green sheet tends to become brittle, while if it is too great, the plasticizer seeps out and handling becomes difficult.

Next, the above dielectric paste is used to form a green sheet 10a to a thickness of preferably 0.5 to 30 μm, more preferably 0.5 to 10 μm or so, on a second support sheet constituted by the carrier sheet 30 by the doctor blade method etc. as shown in FIG. 5A. The green sheet 10a is formed on the carrier sheet 30, then dried. The drying temperature of the green sheet 10a is preferably 50 to 100° C., while the drying time is preferably 1 to 5 minutes.

Next, separate from the carrier sheet 30, as shown in FIG. 4A, a first support sheet constituted by the carrier sheet 20 is prepared, then formed with a release layer 22. Next, the surface of the release layer 22 is formed with an electrode pattern film 12a forming an internal electrode layer 12 after firing.

The electrode pattern film 12a is formed by an electrode paste having inhibitor particles 50 shown in FIG. 2A and FIG. 2B. The formed electrode pattern film 12a has a thickness t1 (see FIG. 4) of preferably 0.1 to 1 μm, more preferably 0.1 to 0.5 μm or so.

The electrode pattern film 12a is formed for example by the printing method. As the printing method, for example, screen printing etc. may be mentioned. When using screen printing, which is one type of printing method, to form an internal electrode layer electrode paste film forming an electrode pattern film 12a on the surface of the release layer 22, the procedure is as follows:

First, the conductive particles to be included in the electrode paste for forming the pattern film 12a and the inhibitor particles for suppressing spheroidization in the firing process are prepared. The conductive particles in the present embodiment are comprised of a metal having nickel as its main ingredient or an alloy with another metal again having nickel as its main ingredient. The ratio of the nickel in the conductive particles is, with respect to the conductive particles as a whole as 100 wt %, preferably 99 to 100 wt %, more preferably 99.5 to 100 wt %. Note that as the metal used as the sub ingredient able to form an alloy with nickel in the conductive particles, for example, Ta, Mo, Zr, Cu, Co, Fe, Nb, W, etc. may be illustrated.

As each of the inhibitor particles, in the present embodiment, the inhibitor particle 50 shown in FIG. 2A is used. This inhibitor particle 50 has a core part 51 comprised of a dielectric particle and a covering layer 52 covering around the core part 51. The dielectric particle forming the core part 51 is not particularly limited, but a dielectric material similar to the dielectric particles for forming the dielectric layers 10 is used.

The core part 51 is not particularly limited in shape, but may be spherical, flake-shaped, projection-shaped, and/or unspecific in shape. In the present embodiment, the case of a spherical shape will be explained. The covering layer 52 covering around the core part 51 does not necessarily have to cover the entire circumference of the core part 51. As shown in FIG. 2B, it may also partially cover the outer circumference of the core part 51.

The core part 51 has a particle size d0 of preferably 10 to 100 nm in range. Further, the covering layer 52 has a thickness t0 of preferably 1 to 15 nm in range, more preferably 1 to 10 nm in range, particularly preferably 1 to 8 nm in range. Further, preferably, the relationship of 0<t0/d0≦0.30 (30%), more preferably 0<t0/d0≦0.15 (15%), stands.

If the covering layer 52 is too small in thickness, the present invention tends to become smaller in action and effect. Further, if the covering layer 52 is too thick, the dispersion ability of the Ni particles and inhibitor particles in the paste becomes poor, after printing, the coating density ρg and flatness become poor, and as a result electrode disconnection tends to increase. Further, the dielectric loss tanδ also tends to increase.

The covering layer 52 is comprised of a metal or alloy having at least type of precious metal element selected from ruthenium (Ru), rhodium (Rh), rhenium (Re), platinum (Pt), iridium (Ir), and osmium (Os), preferably at least one type selected from ruthenium (Ru), rhodium (Rh), rhenium (Re), and platinum (Pt) as a main ingredient. The ratio of these elements included as the main ingredient is, with respect to the entire covering layer 52 as 100 wt %, preferably 99 to 100 wt %, more preferably 99.5 to 100 wt %. As metal ingredients (impurities) which may be contained in the covering layer 52 other than the main ingredients, Cu, Co, Fe, Ta, Nb, W, Zr, Au, Pd, etc. may be mentioned.

To produce inhibitor particles 50 having core parts 51 covered by covering layers 52 in this way, in the present embodiment, the following procedure is performed. First, core powder comprised of barium titanate powder or another dielectric powder, an aqueous solution including a water-soluble metal salt (Pt chloride etc.) including a metal or alloy forming the covering layer, and an aqueous dispersion including a water-soluble polymer compound or surfactant are prepared.

That is, Pt chloride or another water-soluble metal salt is dissolved in water and a water-soluble polymer compound or surfactant is added and uniformly dispersed to prepare an aqueous solution. Next, core powder is charged into the aqueous solution which is then vigorously stirred to uniformly disperse the powder.

Next, the thus prepared aqueous solution of Pt chloride containing the core powder and water-soluble polymer compound or surfactant is charged with a reducing agent to make the Pt precipitate by reduction on the surface of the particles of the core powder constituted by the dielectric powder. At this time, as the reducing material, hydrazine hydrate is preferable. The hydrazine hydrate is preferably further diluted by water to reduce its concentration. Specifically, hydrazine hydrate of 80% concentration is used and diluted to 0.1 wt % by water. If the hydrazine concentration is greater than the above range, Pt of several tens μm or more segregates. The presence of dielectric powder not covered by Pt is sometimes also confirmed. Further, if the concentration is too low, the segregation of Pt will disappear, but the efficiency of recovery of the Pt coating dielectric powder becomes poor in proportion to the use of the large amount of water.

The hydrazine is added while vigorously stirring the aqueous solution. The amount of addition of hydrazine hydrate may be determined considering the amount of Pt chloride. After the reduction-precipitation reaction, the dielectric powder covered by the Pt is repeatedly washed by water several times, then dried at 100° C. in an N₂ flow, then the Pt-coated dielectric powder is heat treated at 200 to 400° C. Note that if less than 200° C., the bondability of the Pt coating and the dielectric particles tends to become poor, while conversely if larger than 400° C., the Pt coating starts to sinter and the adjoining Pt coating inhibitor particles tend to end up reacting.

The thus obtained inhibitor particles 50 may be kneaded with the Ni powder or Ni alloy powder or other conductive particles and the organic vehicle to form a paste and obtain an electrode paste for forming the pattern film 12a. The organic vehicle used may be one similar to the case of the dielectric paste.

When the entire metal ingredient included in the electrode paste is 100 mol %, the inhibitor particles 50 are mixed with the Ni powder or Ni alloy powder or other conductive particles so that the content of the precious metal ingredient for forming the covering layer 52 in the inhibitor particles 50 becomes larger than 0 mol % to 20 mol %.

The obtained electrode paste was formed, as shown in FIG. 4, by for example screen printing on the surface of the release layer 22 in predetermined patterns to thereby obtain predetermined patterns of the electrode pattern film 12a.

Next, separate from the above carrier sheets 20 and 30, as shown in FIG. 4A, a third support sheet constituted by a carrier sheet 26 is formed with a binder layer 28 on its surface to prepare a binder layer transfer sheet. The carrier sheet 26 is comprised of a sheet the same as the carrier sheets 20 and 30.

To form a binder layer on the surface of the electrode pattern film 12a shown in FIG. 4A, in the present embodiment, the transfer method is employed. That is, as shown in FIG. 4B, the binder layer 28 of the carrier sheet 26 is pressed against the surface of the electrode pattern film 12a and hot pressed, then the carrier sheet 26 is peeled off to thereby, as shown in FIG. 4C, transfer the binder layer 28 to the surface of the electrode pattern film 12a.

The heating temperature at this time is preferably 40 to 100° C., further the pressing force is preferably 0.2 to 15 MPa. The pressing may be pressing by a press or pressing by a calendar roll, but is preferably performed by a pair of rolls.

After this, the electrode pattern film 12a is bonded to the surface of the green sheet 10a formed on the surface of the carrier sheet 30 shown in FIG. 5A. For this reason, as shown in FIG. 5B, the electrode pattern film 12a of the carrier sheet 20 is pressed together with the carrier sheet 20 via the binder layer 28 on the surface of the green sheet 10a and hot pressed, as shown in FIG. 5C, to transfer the electrode pattern film 12a to the surface of the green sheet 10a. However, since the carrier sheet 30 on the green sheet side is peeled off, if viewed from the green sheet 10a side, the green sheet 10a is transferred to the electrode pattern film 12a through the binder layer 28.

The heating and pressing at the time of this transfer may be pressing and heating by a press or may be pressing and heating by a calendar roll, but are preferably performed by a pair of rolls. The heating temperature and the pressing force are similar to those when transferring the binder layer 28.

By the processes shown in FIG. 4A to FIG. 5C, a single green sheet 10a is formed with predetermined patterns of an electrode pattern film 12a. This is used to obtain a stack of a large number of alternately stacked electrode pattern films 12a and green sheets 10a.

After this, this stack is finally pressed, then the carrier sheet 20 is peeled off. The pressure at the time of final pressing is preferably 10 to 200 MPa. Further, the heating temperature is preferably 40 to 100° C.

After this, the stack is cut to predetermined sizes to form green chips. Further, the green chips are treated to remove the binder and fired.

When using Ni or another base metal as the conductive particles for forming the internal electrode layers like in the present invention, the atmosphere in the binder removal is preferably made the air or N₂ atmosphere. Further, as other conditions for binder removal, the rate of temperature rise is preferably 5 to 300° C./hour, more preferably 10 to 50° C./hour, the holding temperature is preferably 200 to 400° C., more preferably 250 to 350° C., and the temperature holding time is preferably 0.5 to 20 hours, more preferably 1 to 10 hours.

In the present invention, the green chips are fired in an atmosphere of an oxygen partial pressure of preferably 10⁻¹⁰ to 10⁻² Pa, more preferably 10⁻¹⁰ to 10⁻⁵ Pa. If the oxygen partial pressure at the time of firing is too low, the conductive material of the internal electrode layers abnormally sinters and sometimes ends up disconnecting, while conversely if the oxygen partial pressure is too high, the internal electrode layers tend to oxidize.

In the present invention, the green chips are fired at preferably 1000° C. to less than 1300° C. in temperature. If making the firing temperature less than 1000° C., the sintered dielectric layer becomes insufficient in densification and the electrostatic capacitance tends to become insufficient. Further, if making it 1300° C. or more, the dielectric layers become overfired and the change in capacitance along with time at the time of application of a DC electric field tends to become larger.

As the other firing conditions, the rate of temperature rise is preferably 50 to 500° C./hour, more preferably 200 to 300° C./hour, the temperature holding time is preferably 0.5 to 8 hours, more preferably 1 to 3 hours, and the cooling rate is preferably 50 to 500° C./hour, more preferably 200 to 300° C./hour. Further, the firing atmosphere is preferably made the reducing atmosphere, while as the atmospheric gas, for example, a mixed gas of N₂ and H₂ is preferably used in a wet state.

In the present invention, the fired capacitor chips are preferably annealed. The annealing is treatment for reoxidizing the dielectric layers. Due to this, it is possible to remarkably lengthen the accelerated life of the insulation resistance (IR) and the reliability is improved.

In the present invention, the annealing of the fired capacitor chips is preferably performed under an oxygen partial pressure higher than the reducing atmosphere at the time of firing. Specifically, it is preferably performed under an atmosphere of an oxygen partial pressure of preferably 10⁻² to 100 Pa, more preferably 10⁻² to 10 Pa. If the oxygen partial pressure at the time of annealing is too low, reoxidation of the dielectric layers 2 is difficult, while conversely if too high, the nickel of the internal electrode layers tends to oxidize and form insulators.

In the present invention, the annealing holding temperature or maximum temperature is preferably made 1200° C. or less, more preferably 900 to 1150° C., particularly preferably 1000 to 1100° C. Further, in the present invention, the holding time at those temperatures is preferably 0.5 to 4 hours, more preferably 1 to 3 hours. If the annealing holding temperature or maximum temperature is less than that range, the dielectric material insufficiently oxidizes, so the insulation resistance life tends to become shorter, while if over that range, not only does the Ni of the internal electrodes oxidize and cause the capacitance to fall, but also it ends up reacting with the dielectric material resulting in the life becoming shorter. Note that the annealing may also be comprised of just a temperature raising process and a temperature lowering process. That is, the temperature holding time may also be made zero. In this case, the holding temperature is synonymous with the maximum temperature.

As the other annealing conditions, the cooling rate is preferably 50 to 500° C./hour, more preferably 100 to 300° C./hour. Further, the atmospheric gas of the annealing is preferably, for example, wet N₂ gas etc.

Note that the N₂ gas may be wet by for example a wetter etc. In this case, the water temperature is preferably 0 to 75° C. or so. The binder removal, firing, and annealing may be performed consecutively and may be performed independently. When performing them consecutively, it is preferable to first remove the binder, then change the atmosphere without cooling, raise the temperature to the firing holding temperature for the firing, then cool and change the atmosphere when reaching the annealing holding temperature for the annealing. On the other hand, when performing them independently, during firing, it is preferable to raise the temperature up to the binder removal holding temperature under an N₂ gas or wet N₂ gas atmosphere, then change the atmosphere and continue to further raise the temperature. After cooling to the annealing holding temperature, it is preferable to again change to an N₂ gas or wet N₂ gas atmosphere and further continue the cooling. Further, at the time of annealing, it is also possible to raise the temperature under an N₂ gas atmosphere to the holding temperature, then change the atmosphere or to maintain a wet N₂ gas atmosphere throughout the entire process of annealing.

The thus obtained sintered article (device body 4) is for example polished at its end faces by barrel polishing, sandblasting, etc. and baked with terminal electrode paste to form the terminal electrodes 6 and 8. The firing conditions of the terminal electrode paste are preferably for example firing under a wet N₂ and H₂ mixed gas at 600 to 800° C. for 10 minutes to 1 hour or so. Further, in accordance with need, the terminal electrodes 6 and 8 may be plated etc. to form pad layers. Note that the terminal electrode paste may be prepared in the same way as the above-mentioned electrode paste.

The thus produced multilayer ceramic capacitor of the present invention is mounted by soldering etc. on a printed circuit board for use in various types of electronic equipment etc.

In the present embodiment, it is possible to provide a multilayer ceramic capacitor 2 in which a drop in the electrostatic capacitance is effectively suppressed. Ru, Rh, Re, Pt, Ir, and Os are precious metals with melting points higher than Ni. Further, covering layers 52 having such a metal or its alloy as a main ingredient are superior in wettability and bondability with the ceramic green sheets 10a. Therefore, by using an electrode paste including inhibitor particles 50 having such covering layers 52 together with conductive particles of Ni or another base metal to form an electrode pattern film 12a, it is possible to suppress particle growth of the Ni particles in the firing stage, effectively prevent spheroidization, electrode disconnection, etc., and effectively suppress a drop in the electrostatic capacitance. Further, it is possible to prevent delamination of the internal electrode layers 12 and dielectric layers 10 obtained after firing. Further, there are no firing defects of the dielectric powder.

Further, according to the method of production of the present embodiment, inhibitor particles 50 optimal for use as inhibitor particles included in the electrode paste for forming the internal electrode layers 12 of a multiplayer ceramic capacitor 2 having internal electrode layers 12 and dielectric layers 10 can be produced with a high efficiency without causing abnormal segregation (segregated particles of several μm size) etc. That is, according to the method of production of the present embodiment, it is possible to prevent the formation of precious metal (for example Pt) segregated particles of several μm size and form a good Pt or other covering layer on the surface of dielectric particles or other core powder of 100 nm or smaller size.

Note that the present invention is not limited to the above-mentioned embodiments and may be modified in various ways within the scope of the present invention.

For example, the present invention is not limited to a multilayer ceramic capacitor and may also be applied to another electronic device.

Below, the present invention will be explained based on more detailed examples, but the present invention is not limited to these examples.

### EXAMPLES

### Example 1

1 g of Pt chloride hydrate was dissolved in 1 liter of water, 1 g of PVA with a saponification degree of 88 mol % (one example of a water-soluble polymer compound) (0.1 wt % with respect to Pt chloride aqueous solution) was added, and the mixture was vigorously stirred to prepare a Pt chloride aqueous solution. Next, dielectric powder having an average particle size of 50 nm was charged in an amount of 3 g into the Pt chloride aqueous solution which was then stirred to prepare an aqueous dispersion. Note that the dielectric powder used was BT-005 (made by Sakai Chemical Industry).

Further, separate from this aqueous dispersion, hydrazine hydrate 80% in an amount of 0.47 g was added to 470 ml of water to prepare a uniformly mixed hydrazine aqueous solution.

Next, while vigorously stirring the previously prepared Pt chloride aqueous solution containing the dielectric powder at room temperature, the hydrazine aqueous solution was gradually added at a rate of about 10 ml/min. By the addition of this hydrazine aqueous solution, a dielectric powder having a Pt covering layer was produced. This was rinsed several times and dried at 100° C. in temperature for 12 hours, then was heat treated at a temperature of 300° C. to obtain 3.45 g of inhibitor particles powder.

This heat treated powder was observed by a scan type electron microscope, whereupon there was no Pt segregation. Further, this was observed by a TEM, whereupon it was confirmed that the surfaces of the dielectric particles had tens of 5 nm or smaller Pt particles bonded to them.

### Example 2

Except for replacing the PVA with another example of a water-soluble polymer compound, that is, a copolymer of methyl acrylate and acrylic acid (acid value 10 mgKOH/g, molecular weight 100,000), the same procedure was followed as in Example 1 to produce inhibitor particle powder which was observed in the same way as in Example 1.

The heat treated powder obtained in this example was observed by a scan type electron microscope, whereupon there was no segregation of Pt. Further, this was observed by a-TEM, whereupon it was confirmed that the surfaces of the dielectric particles had tens of Pt particles of 5 nm or smaller size bonded to them.

### Example 3

Except for replacing the PVA with an acetylene diol-based nonionic surfactant (HLB value 10), the same procedure was followed as in Example 1 to produce an inhibitor powder which was observed in the same way as in Example 1.

The heat treated powder obtained in this example was observed by a scan type electron microscope, whereupon there was no segregation of Pt. Further, this was observed by a TEM, whereupon it was confirmed that the surfaces of the dielectric particles had tens of Pt particles of 5 nm or smaller size bonded to them.

### Comparative Example 1

Except for not adding PVA, the same procedure was followed as in Example 1 to prepare inhibitor particle powder which was observed in the same way as in Example 1.

The heat treated powder obtained in this comparative example was observed by a scan type electron microscope, whereupon segregated Pt particles of several μm or larger sizes were observed. Good Pt coated dielectric particles could not be obtained. That is, in this Comparative Example 1, segregated Pt particles of 20 μm or longer length were observed. It was confirmed that there was much dielectric particle powder not covered by Pt.

### Example 11

Preparation of Pastes

First, BaTiO₃ powder (BT-02/Sakai Chemical Industry) and different powders selected from MgCO₃, MnCO₃, (Ba_{0.6}Ca_{0.4})SiO₃, and a rare earth (Gd₂O₃, Tb₄ O₇, Dy₂O₃, Ho₂O₃, Er₂O₃, Tm₂O₃, Yb₂O₃, Lu₂O₃, and Y₂O₃) were wet mixed by ball mills for 16 hours and then dried to obtain different dielectric materials. These material powders had average particle sizes of 0.1 to 1 μm. The (Ba_{0.6}Ca_{0.4})SiO₃ was prepared by wet mixing BaCO₃, CaCO₃, and SiO₂ by a ball mill, drying the mixture, firing it in the air, then wet crushing it by a ball mill.

Each obtained dielectric material was made into a paste by adding an organic vehicle to a dielectric material, then mixing the result by a ball mill to obtain a dielectric green sheet paste. The organic vehicle included, with respect to the dielectric material as 100 parts by weight, a binder comprised of polyvinyl butyral in an amount of 6 parts by weight, a plasticizer comprised of bis(2-ethylhexyl) phthalate (DOP) in an amount of 3 parts by weight, ethyl acetate in an amount of 55 parts by weight, toluene in an amount of 10 parts by weight, and a release agent comprised of paraffin in an amount of 0.5 part by weight.

Next, the dielectric green sheet paste was diluted by ethanol/toluene (55/10) two-fold by weight ratio for use as the release layer paste.

Next, except for not introducing the dielectric particles and release agent, a similar dielectric green sheet paste was diluted by toluene four-fold by weight ratio for use as the binder layer paste.

Formation of Green Sheet

First, each dielectric green sheet paste was used to form a green sheet of a thickness of 1.0 μm on a PET film (second support sheet) by a wire bar coater.

Formation of Internal Electrode Layer Film

Each release layer paste was coated and dried on a separate PET film (first support sheet) by a wire bar coater to form a release layer of a thickness of 0.3 μm.

Next, the surface of the release layer was screen printed on by the electrode paste. The electrode paste included the inhibitor particles 50 shown in FIG. 2. The inhibitor particles 50 were produced as follows. First, core parts 51 comprised of dielectric powder made of BaTiO₃ were prepared. This dielectric powder had an average particle size of 0.05 μm (50 nm).

This dielectric powder was treated by a similar method as in Example 1 to form covering layers 52 made of Pt particles. These inhibitor particles were observed by a transmission electron microscope and crystal structure analysis. As a result, it could be confirmed that the dielectric particles were covered by 5 nm of Pt from the surface. That is, t0/d0 was 0.10 (10%).

The inhibitor particles 50 were kneaded together with conductive particles made of 100% Ni powder having an average particle size of 0.1 μm (100 nm) and an organic vehicle by the following ratio by a triple roll mill to make a slurry and obtain an internal electrode paste. That is, to the conductive particles as 100 parts by weight, the inhibitor particles 50 in an amount of 20 parts by weight and the organic vehicle (binder resin comprised of ethyl cellulose resin in an amount of 4.5 parts by weight dissolved in terpineol in an amount of 228 parts by weight) were added and the result kneaded by a triple roll mill to make a slurry for use as an internal electrode paste (electrode paste).

This internal electrode paste was used for screen printing, as shown in FIG. 4A to FIG. 4C, to form the surface of the release layer with predetermined patterns of the electrode pattern film 12a. This pattern film 12a was dried to a thickness of 0.5 μm.

Formation of Binder Layer

The binder layer paste was coated and dried on a separate PET film (third support sheet) treated for release by a silicone-based resin by a wire bar coater to form a binder layer 28 of a thickness of 0.2 μm.

Formation of Final Stack (Before Firing Device Body)

First, the binder layer 28 was transferred to the surface of each electrode pattern film 12a by the method shown in FIG. 4A to FIG. 4C. At the time of transfer, a pair of rolls were used. The pressing force was 0.1 MPa, and the temperature was 80° C.

Next, the method shown in FIG. 5 was used to bond (transfer) the electrode pattern film 12a through the binder layer 28 to the surface of the green sheet 10a. At the time of transfer, a pair of rolls was used. The pressing force was 0.1 MPa, and the temperature was 80° C.

Next, electrode pattern films 12a and green sheets 10a were successively stacked to finally obtain a final stack comprised of 21 layers of electrode pattern films 12a. The stacking conditions were a pressing force of 50 MPa and a temperature of 120° C.

Preparation of Sintered Article

Next, each final stack was cut to a predetermined size which was then treated to remove the binder, fired, and annealed (heat treated) to prepare a chip shaped sintered articls.

The binder was removed by:

Rate of temperature rise: 5 to 300° C./hour,

Holding temperature: 200 to 400° C.,

Holding time: 0.5 to 20 hours,

Atmospheric gas: wet N₂.

The firing was performed by:

Rate of temperature rise: 5 to 500° C./hour,

Holding temperature: 1200° C.,

Holding time: 0.5 to 8 hours,

Cooling rate: 50 to 500° C./hour,

Atmospheric gas: wet mixed gas of N₂ and H₂,

Oxygen partial pressure: 10⁻⁷ Pa.

The annealing (reoxidation) was performed by:

Rate of temperature rise: 200 to 300° C./hour,

Holding temperature: 1050° C.,

Holding time: 2 hours,

Cooling rate: 300° C./hour,

Atmospheric gas: wet N₂ gas,

Oxygen partial pressure: 10⁻¹ Pa.

Note that the atmospheric gas was wet using a wetter at a water temperature of 0 to 75° C.

Next, each chip shaped sintered article was polished at its end faces by sandblasting, then the external electrode paste was transferred to the end faces and fired in a wet N₂+H₂ atmosphere at 800° C. for 10 minutes to form external electrodes and thereby obtain a sample of a multilayer ceramic capacitor of the configuration shown in FIG. 1.

Each sample obtained in this way had a size of 3.2 mm×1.6 mm×0.6 mm. Each sample had 21 dielectric layers sandwiched between internal electrode layers, the thickness of the dielectric layers was 1 μm, and the thickness of the internal electrode layers 12 was 0.5 μm. The thicknesses of the layers (film thickness) was measured by observation by an SEM.

Further, each sample was evaluated for electric characteristics (electrostatic capacitance C and dielectric loss tanδ). The results are shown in Table 1. The electric characteristics (electrostatic capacitance C and dielectric loss tanδ) were evaluated as follows.

The electrostatic capacitance C (unit: μF) was measured for each sample at a reference temperature of 25° C. by a digital LCR meter (YHP 4274A) under conditions of a frequency of 1 kHz and an input signal level (measurement voltage) of 1 Vrms. The electrostatic capacitance C was preferably a good 0.9 μF or more.

The dielectric loss tanδ was measured at 25° C. by a digital LCR meter (YHP 4274A) under conditions of a frequency of 1 kHz and an input signal level (measurement voltage) of 1 Vrms. The dielectric loss tanδ was preferably less than 0.1.

Note that these characteristic values were found from the average value of the values measured using sample number n=10. These results are shown in Table 1. Note that in Table 1, the “good” in the evaluation criteria column shows good results in all characteristics, while the “poor” indicates good results could not be obtained in one or more of the characteristics.

TABLE 1

| | Core part | Coating | | Electrostatic | | |
|---|---|---|---|---|---|---|
| | dielectric | thickness | | capacitance | | |
| | powder (nm) | (nm) Pt | t0/d0 (%) | (μF) | tanδ | Evaluation |
| Comp. Ex. 11 | 50 | 0 | 0 | 0.77 | 0.04 | Poor |
| Ex. 11 | 50 | 5 | 10 | 1.04 | 0.04 | Good |
| Ex. 12 | 50 | 5 | 10 | 1.07 | 0.04 | Good |
| Ex. 13 | 50 | 5 | 10 | 1.08 | 0.03 | Good |

### Comparative Example 11

Except for using dielectric powder not formed with the covering layers 52 shown in FIG. 2, the same procedure was followed as in Example 11 to prepare capacitor samples which were measured in the same way as in Example 11. The results are shown in Table 1.

### Example 12

Except for using the inhibitor particle powder obtained by the method shown in Example 2, the same procedure was followed as in Example 11 to prepare capacitor samples which were measured in the same way as in Example 11. The results are shown in Table 1.

### Example 13

Except for using the inhibitor particle powder obtained by the method of Example 3, the same procedure was followed as in Example 11 to prepare capacitor samples which were measured in the same way as in Example 11. The results are shown in Table 1.

Evaluation 1

As shown in Table 1, the effectiveness of the present invention was confirmed.

### Examples 21a to 21d and Comparative Example 21

Except for making the average particle size of the dielectric powder of the core parts 51 0.05 μm and changing the thickness of the covering layers 52 as shown in Table 2, the same procedure was followed as in Example 11 to prepare capacitor samples which were measured in the same way as in Example 11. The results are shown in Table 2. As shown in Table 2, it was confirmed that the ratios of the thickness t0 of the covering layers to the particle size d0 of the core parts (t0/d0) were in the preferable range.

### Examples 31a to 31d

Except for changing the material of the covering layers 52 from Pt to Ru, the same procedure was followed as in Examples 21a to 21d to prepare capacitor samples which were measured in the same way as in Examples 21a to 21d. The results are shown in Table 3. As shown in Table 3, it was confirmed that even if replacing Pt with Ru, there were the same effects as in Examples 21a to 21d.

### Examples 41a to 41d

Except for changing the material of the covering layers 52 from Pt to Rh, the same procedure was followed as in Examples 21a to 21d to prepare capacitor samples which were measured in the same way as in Examples 21a to 21d. The results are shown in Table 4. As shown in Table 4, it was confirmed that even if replacing Pt with Rh, there were the same effects as in Examples 21a to 21d.

### Examples 51a to 51d

Except for changing the material of the covering layers 52 from Pt to Re, the same procedure was followed as in Examples 21a to 21d to prepare capacitor samples which were measured in the same way as in Examples 21a to 21d. The results are shown in Table 5. As shown in Table 5, it was confirmed that even if replacing Pt with Re, there were the same effects as in Examples 21a to 21d.

### Examples 61a to 61d

Except for changing the material of the covering layers 52 from Pt to Ir, the same procedure was followed as in Examples 21a to 21d to prepare capacitor samples which were measured in the same way as in Examples 21a to 21d. The results are shown in Table 6. As shown in Table 6, it was confirmed that even if replacing Pt with Ir, there were the same effects as in Examples 21a to 21d.

### Examples 71a to 71d

Except for changing the material of the covering layers 52 from Pt to Os, the same procedure was followed as in Examples 21a to 21d to prepare capacitor samples which were measured in the same way as in Examples 21a to 21d. The results are shown in Table 7. As shown in Table 7, it was confirmed that even if replacing Pt with Os, there were the same effects as in Examples 21a to 21d.

TABLE 2

| | Core part | Coating | | Electrostatic | | |
|---|---|---|---|---|---|---|
| | dielectric | thickness | | capacitance | | |
| | powder (nm) | (nm) Pt | t0/d0 (%) | (μF) | tanδ | Evaluation |
| Comp. Ex. 21 | 50 | 0 | 0 | 0.75 | 0.03 | Poor |
| Ex. 21a | 50 | 3 | 6 | 1 | 0.04 | Good |
| Ex. 21b | 50 | 5 | 10 | 1.04 | 0.04 | Good |
| Ex. 21c | 50 | 15 | 30 | 1.06 | 0.06 | Good |
| Ex. 21d | 50 | 23 | 46 | 0.91 | 0.12 | Poor |

TABLE 3

| | Core part | Coating | | Electrostatic | | |
|---|---|---|---|---|---|---|
| | dielectric | thickness | | capacitance | | |
| | powder (nm) | (nm) Pt | t0/d0 (%) | (μF) | tanδ | Evaluation |
| Comp. Ex. 21 | 50 | 0 | 0 | 0.75 | 0.03 | Poor |
| Ex. 31a | 50 | 3 | 6 | 0.99 | 0.03 | Good |
| Ex. 31b | 50 | 6 | 12 | 1.02 | 0.04 | Good |
| Ex. 31c | 50 | 13 | 26 | 1.04 | 0.04 | Good |
| Ex. 31d | 50 | 24 | 48 | 0.91 | 0.15 | Poor |

TABLE 4

| | Core part | Coating | | Electrostatic | | |
|---|---|---|---|---|---|---|
| | dielectric | thickness | | capacitance | | |
| | powder (nm) | (nm) Pt | t0/d0 (%) | (μF) | tanδ | Evaluation |
| Comp. Ex. 21 | 50 | 0 | 0 | 0.75 | 0.03 | Poor |
| Ex. 41a | 50 | 3 | 6 | 0.96 | 0.03 | Good |
| Ex. 41b | 50 | 9 | 18 | 1 | 0.04 | Good |
| Ex. 41c | 50 | 15 | 30 | 1.03 | 0.04 | Good |
| Ex. 41d | 50 | 23 | 46 | 0.9 | 0.15 | Poor |

TABLE 5

| | Core part | Coating | | Electrostatic | | |
|---|---|---|---|---|---|---|
| | dielectric | thickness | | capacitance | | |
| | powder (nm) | (nm) Pt | t0/d0 (%) | (μF) | tanδ | Evaluation |
| Comp. Ex. 21 | 50 | 0 | 0 | 0.75 | 0.03 | Poor |
| Ex. 51a | 50 | 5 | 10 | 1.02 | 0.03 | Good |
| Ex. 51b | 50 | 10 | 20 | 1.05 | 0.04 | Good |
| Ex. 51c | 50 | 15 | 30 | 1.04 | 0.04 | Good |
| Ex. 51d | 50 | 24 | 48 | 0.92 | 0.15 | Poor |

TABLE 6

| | Core part | Coating | | Electrostatic | | |
|---|---|---|---|---|---|---|
| | dielectric | thickness | | capacitance | | |
| | powder (nm) | (nm) Pt | t0/d0 (%) | (μF) | tanδ | Evaluation |
| Comp. Ex. 21 | 50 | 0 | 0 | 0.75 | 0.03 | Poor |
| Ex. 61a | 50 | 5 | 10 | 1.03 | 0.04 | Good |
| Ex. 61b | 50 | 10 | 20 | 1.02 | 0.04 | Good |
| Ex. 61c | 50 | 15 | 30 | 1.05 | 0.05 | Good |
| Ex. 61d | 50 | 25 | 50 | 0.93 | 0.15 | Poor |

TABLE 7

| | Core part | Coating | | Electrostatic | | |
|---|---|---|---|---|---|---|
| | dielectric | thickness | | capacitance | | |
| | powder (nm) | (nm) Pt | t0/d0 (%) | (μF) | tanδ | Evaluation |
| Comp. Ex. 21 | 50 | 0 | 0 | 0.75 | 0.03 | Poor |
| Ex. 71a | 50 | 4 | 8 | 1.01 | 0.04 | Good |
| Ex. 71b | 50 | 11 | 22 | 1.03 | 0.05 | Good |
| Ex. 71c | 50 | 15 | 30 | 1.05 | 0.06 | Good |
| Ex. 71d | 50 | 23 | 46 | 0.94 | 0.15 | Poor |

### Examples 121a to 121c

Except for making the average particle size of the dielectric powder of the core parts 51 0.05 μm and changing the thickness of the covering layers 52 and the amount of Pt (mol %) as shown in Table 8, the same procedure was followed as in Example 11 to prepare capacitor samples. Note that the amount of Pt in the examples was the ratio of Pt included in the electrode paste used for preparation of the samples with respect to the entire metal ingredient included as 100 mol %. Each prepared sample was measured for the electrode coverage rate, breakdown voltage, and equivalent serial resistance. The results are shown in Table 8. Note that in Table 8 to Table 13, the numerical values in the left columns in each field are numerical values of the example, while the numerical values at the right columns are numerical values of the comparative examples.

(Measurement of Electrode Coverage Rate)

The electrode coverage rate of the internal electrodes was found by cutting a sample of the multilayer ceramic capacitor so that the surfaces of the electrodes are exposed, observing the surfaces of the electrodes by an SEM, and image processing the metal micrograph of the polished faces.

(Measurement of Breakdown Voltage)

For the breakdown voltage VB (unit: V), the value of the voltage at the time of a voltage raising speed of 100V/sec and a detection current of 10 mA was measured.

(Measurement of Equivalent Serial Resistance)

The equivalent serial resistance ESR (unit: mΩ) was measured by using an impedance analyzer (HP 4194A) to measure the frequency-ESR characteristic under a measurement voltage of 1 Vrms and reading the value at which the impedance became the smallest.

### Comparative Example 111

Except for using the dielectric powder not formed with the covering layers 52 shown in FIG. 2 as the inhibitor particles, the same procedure was followed as in Example 11 to prepare capacitor samples. This Comparative Example 111 was measured in the same way as in Examples 121a to 121c. The results are shown in Table 8.

### Comparative Examples 121x to 121z

Except for replacing the Ni particles with the use of a Ni—Pt alloy powder, the same procedure was followed as in Comparative Example 111 to prepare capacitor samples. These Comparative Examples 121x to 121z were then similarly measured as in Examples 121a to 121c. The results are shown in Table 8.

An Ni and Pt alloy powder was obtained by using sputtering or another thin film forming method to obtain an alloy film, then peeling off the alloy film and crushing it by a ball mill and classifying the pieces. The Ni and Pt alloy powder used for preparation had an average particle size of 0.2 μm. The amount of Pt (mol %) was as shown in Table 8. Note that the amounts (mol %) of precious metal (Pt, Ru, Rh, Re, Ir, and Os) in the comparative examples are the ratios of Pt to the Ni included in the alloy.

### Examples 131a to 131c

Except for changing the material of the covering layers 52 from Pt to Ru and changing the thickness of the covering layers 52 and the amount of Ru (mol %) as shown in Table 9, the same procedure was followed as in Examples 121a to 121c to prepare capacitor samples which were then similarly measured. The results are shown in Table 9.

### Comparative Examples 131x to 131z

Except for changing the material of the alloy from Ni—Pt to Ni—Ru and changing the amount of Ru (mol %) as shown in Table 9, the same procedure was followed as in Comparative Examples 121x to 121z to prepare capacitor samples which were then similarly measured. The results are shown in Table 9.

### Examples 141a to 141c

Except for changing the material of the covering layers 52 from Pt to Rh and changing the thickness of the covering layers 52 and the amount of Rh (mol %) as shown in Table 10, the same procedure was followed as in Examples 121a to 121c to prepare capacitor samples which were then similarly measured. The results are shown in Table 10.

### Comparative Examples 141x to 141z

Except for changing the material of the alloy from Ni—Pt to Ni—Rh and changing the amount of Rh (mol %) as shown in Table 10, the same procedure was followed as in Comparative Examples 121x to 121z to prepare capacitor samples which were then similarly measured. The results are shown in Table 10.

### Examples 151a to 151c

Except for changing the material of the covering layers 52 from Pt to Re and changing the thickness of the covering layers 52 and the amount of Re (mol %) as shown in Table 11, the same procedure was followed as in Examples 121a to 121c to prepare capacitor samples which were then similarly measured. The results are shown in Table 11.

### Comparative Examples 151x to 151z

Except for changing the material of the alloy from Ni—Pt to Ni—Re and changing the amount of Re (mol %) as shown in Table 11, the same procedure was followed as in Comparative Examples 121x to 121z to prepare capacitor samples which were then similarly measured. The results are shown in Table 11.

### Examples 161a to 161c

Except for changing the material of the covering layers 52 from Pt to Ir and changing the thickness of the covering layers 52 and the amount of Ir (mol %) as shown in Table 12, the same procedure was followed as in Examples 121a to 121c to prepare capacitor samples which were then similarly measured. The results are shown in Table 12.

### Comparative Examples 161x to 161z

Except for changing the material of the alloy from Ni—Pt to Ni—Ir and changing the amount of Ir (mol %) as shown in Table 12, the same procedure was followed as in Comparative Examples 121x to 121z to prepare capacitor samples which were then similarly measured. The results are shown in Table 12.

### Examples 171a to 171c

Except for changing the material of the covering layers 52 from Pt to Os and changing the thickness of the covering layers 52 and the amount of Os (mol %) as shown in Table 13, the same procedure was followed as in Examples 121a to 121c to prepare capacitor samples which were then similarly measured. The results are shown in Table 13.

### Comparative Examples 171x to 171z

Except for changing the material of the alloy from Ni—Pt to Ni—Os and changing the amount of Os (mol %) as shown in Table 13, the same procedure was followed as in Comparative Examples 121x to 121z to prepare capacitor samples which were then similarly measured. The results are shown in Table 13.

Evaluation 2

As shown in Table 8 to Table 13, the multilayer ceramic capacitors prepared using the coating powders prepared in the examples had higher electrode coverage rates after firing when viewed by the same precious metal content compared with the multilayer ceramic capacitors prepared using powder prepared by the comparative examples. As a result, it was confirmed that the breakdown voltages VB tended to be improved. This is believed because spheroidization of the electrodes after baking was suppressed, the variation in electrode thickness became smaller, and as a result the distances between dielectric layers became uniform.

Further, when viewed by the same precious metal content, it was confirmed that the equivalent serial resistance (ESR) tended to become smaller in the capacitors prepared by the examples compared with the capacitors prepared by the comparative examples. By making the equivalent serial resistance small, it is possible to reduce the power loss (heat generation).

TABLE 8

| | | | | Pt covering layer | | Electrode coverage | | Breakage | | Equivalent serial | |
|---|---|---|---|---|---|---|---|---|---|---|---|
| | | Pt amount (mol %) | | (nm) | | rate (%) | | voltage (V) | | resistance (Ω) | |
| | | Covering | Ni—Pt | Covering | Ni—Pt | Covering | Ni—Pt | Covering | Ni—Pt | Covering | Ni—Pt |
| | | inhibitor | alloy | inhibitor | alloy | inhibitor | alloy | inhibitor | alloy | inhibitor | alloy |
| Comp. Ex. 111 | | 0 | | — | | 62 | | 110 | | 8.1 | |
| Ex. 121a | Comp. Ex. 121x | 1 | 1 | 3 | — | 81 | 76 | 158 | 141 | 8.4 | 9 |
| Ex. 121b | Comp. Ex. 121y | 6.5 | 6.5 | 5 | — | 86 | 78 | 171 | 145 | 11.2 | 12.5 |
| Ex. 121c | Comp. Ex. 121z | 15 | 15 | 15 | — | 88 | 80 | 177 | 149 | 13.6 | 17.2 |

TABLE 9

| | | | | Ru covering layer | | Electrode coverage | | Breakage | | Equivalent serial | |
|---|---|---|---|---|---|---|---|---|---|---|---|
| | | Ru amount (mol %) | | (nm) | | rate (%) | | voltage (V) | | resistance (Ω) | |
| | | Covering | Ni—Ru | Covering | Ni—Ru | Covering | Ni—Ru | Covering | Ni—Ru | Covering | Ni—Ru |
| | | inhibitor | alloy | inhibitor | alloy | inhibitor | alloy | inhibitor | alloy | inhibitor | alloy |
| Comp. Ex. 111 | | 0 | | — | | 62 | | 110 | | 8.1 | |
| Ex. 131a | Comp. Ex. 131x | 1 | 1 | 3 | — | 82 | 73 | 158 | 131 | 8.3 | 8.9 |
| Ex. 131b | Comp. Ex. 131y | 7 | 7 | 6 | — | 86 | 77 | 171 | 141 | 11.3 | 13.8 |
| Ex. 131c | Comp. Ex. 131z | 18.4 | 18.4 | 13 | — | 87 | 79 | 178 | 149 | 13.4 | 16.3 |

TABLE 10

| | | | | Rh covering layer | | Electrode coverage | | Breakage | | Equivalent serial | |
|---|---|---|---|---|---|---|---|---|---|---|---|
| | | Rh amount (mol %) | | (nm) | | rate (%) | | voltage (V) | | resistance (Ω) | |
| | | Covering | Ni—Rh | Covering | Ni—Rh | Covering | Ni—Rh | Covering | Ni—Rh | Covering | Ni—Rh |
| | | inhibitor | alloy | inhibitor | alloy | inhibitor | alloy | inhibitor | alloy | inhibitor | alloy |
| Comp. Ex. 111 | | 0 | | — | | 62 | | 110 | | 8.1 | |
| Ex. 141a | Comp. Ex. 141x | 1 | 1 | 3 | — | 79 | 71 | 146 | 129 | 8.6 | 9 |
| Ex. 141b | Comp. Ex. 141y | 7 | 7 | 9 | — | 83 | 73 | 160 | 134 | 11.9 | 12.3 |
| Ex. 141c | Comp. Ex. 141z | 18.4 | 18.4 | 15 | — | 86 | 78 | 169 | 145 | 14 | 17.8 |

TABLE 11

| | | | | Re covering layer | | Electrode coverage | | Breakage | | Equivalent serial | |
|---|---|---|---|---|---|---|---|---|---|---|---|
| | | Re amount (mol %) | | (nm) | | rate (%) | | voltage (V) | | resistance (Ω) | |
| | | Covering | Ni—Re | Covering | Ni—Re | Covering | Ni—Re | Covering | Ni—Re | Covering | Ni—Re |
| | | inhibitor | alloy | inhibitor | alloy | inhibitor | alloy | inhibitor | alloy | inhibitor | alloy |
| Comp. Ex. 111 | | 0 | | — | | 62 | | 110 | | 8.1 | |
| Ex. 151a | Comp. Ex. 151x | 1 | 1 | 5 | — | 84 | 78 | 161 | 142 | 8.5 | 9.1 |
| Ex. 151b | Comp. Ex. 151y | 6.4 | 6.4 | 10 | — | 89 | 80 | 174 | 147 | 11.6 | 14.8 |
| Ex. 151c | Comp. Ex. 151z | 14.8 | 14.8 | 15 | — | 91 | 81 | 181 | 151 | 13.4 | 18 |

TABLE 12

| | | | | Ir covering layer | | Electrode coverage | | Breakage | | Equivalent serial | |
|---|---|---|---|---|---|---|---|---|---|---|---|
| | | Ir amount (mol %) | | (nm) | | rate (%) | | voltage (V) | | resistance (Ω) | |
| | | Covering | Ni—Ir | Covering | Ni—Ir | Covering | Ni—Ir | Covering | Ni—Ir | Covering | Ni—Ir |
| | | inhibitor | alloy | inhibitor | alloy | inhibitor | alloy | inhibitor | alloy | inhibitor | alloy |
| Comp. Ex. 111 | | 0 | | — | | 62 | | 110 | | 8.1 | |
| Ex. 161a | Comp. Ex. 161x | 1 | 1 | 5 | — | 79 | 72 | 157 | 130 | 8.7 | 9.2 |
| Ex. 161b | Comp. Ex. 161y | 6.7 | 6.7 | 10 | — | 80 | 71 | 149 | 132 | 11.0 | 12.2 |
| Ex. 161c | Comp. Ex. 161z | 17.5 | 17.5 | 15 | — | 90 | 77 | 180 | 143 | 13.8 | 17 |

TABLE 13

| | | | | Os covering layer | | Electrode coverage | | Breakage | | Equivalent serial | |
|---|---|---|---|---|---|---|---|---|---|---|---|
| | | Os amount (mol%) | | (nm) | | rate (%) | | voltage (V) | | resistance (Ω) | |
| | | Covering | Ni—Os | Covering | Ni—Os | Covering | Ni—Os | Covering | Ni—Os | Covering | Ni—Os |
| | | inhibitor | alloy | inhibitor | alloy | inhibitor | alloy | inhibitor | alloy | inhibitor | alloy |
| Comp. Ex. 111 | | 0 | | — | | 62 | | 110 | | 8.1 | |
| Ex. 171a | Comp. Ex. 171x | 1 | 1 | 4 | — | 80 | 70 | 159 | 128 | 8.6 | 9.1 |
| Ex. 171b | Comp. Ex. 171y | 6.8 | 6.8 | 11 | — | 79 | 72 | 147 | 133 | 11.2 | 12.4 |
| Ex. 171c | Comp. Ex. 171z | 17.8 | 17.8 | 15 | — | 89 | 77 | 179 | 144 | 13.7 | 17.9 |

1. An inhibitor particle contained in an electrode paste for forming an electrode together with conductive particles contained in said electrode paste,
said inhibitor particle having
a core part comprised of a dielectric particle and
a covering layer covering around said core part,
said covering layer being comprised of a precious metal.

2. The inhibitor particle as set forth in claim 1, wherein said precious metal is comprised of a metal or alloy having at least one element selected from ruthenium (Ru), rhodium (Rh), rhenium (Re), platinum (Pt), iridium (Ir), and osmium (Os) as its main ingredient.

3. The inhibitor particle as set forth in claim 2, wherein said precious metal is a metal or alloy having at least one element selected from ruthenium (Ru), rhodium (Rh), rhenium (Re), and platinum (Pt) as its main ingredient.

4. The inhibitor particle as set forth in claim 1, wherein said core part is covered continuously or discontinuously by said covering layer.

5. The inhibitor particle as set forth in claim 1, wherein said core part has a particle size of 10 nm to 100 nm.

6. The inhibitor particle as set forth in claim 1, wherein said covering layer has a thickness of 1 to 15 nm.

7. An electrode paste having inhibitor particles as set forth in claim 1, conductive particles, a solvent, a binder resin, and a dispersant.

8. The electrode paste as set forth in claim 7, wherein said conductive particles are base metal particles.

9. The alloy electrode paste as set forth in claim 8, wherein said conductive particles are nickel metal particles or nickel-containing alloy particles.

10. The electrode paste as set forth in claim 7, wherein when the entire metal ingredient contained in said electrode paste is 100 mol %, the content of the precious metal ingredient forming said covering layer is larger than 0 mol % to 20 mol %.

11. A method of production of an electronic device having internal electrode layers and dielectric layers,
said method of production of an electronic device comprising the steps of;
using an electrode paste as set forth in claim 8 to form electrode pattern films forming said internal electrode layers,
stacking said electrode pattern films with green sheets forming dielectric layers after firing, and
firing the stack of said green sheets and said electrode pattern films.

12. The method of production of an electronic device as set forth in claim 11, wherein said dielectric layers are a dielectric material able to be fired in a reducing atmosphere.

13. The method of production of an electronic device as set forth in claim 11, wherein said internal electrode layers have a thickness after firing of 1 μm or less.

14. An electronic device produced by the method of production of an electronic device as set forth in claim 11, wherein each internal electrode layer after firing has a coverage rate, showing a ratio of the area which said internal electrode layer after firing actually covers said dielectric layer with respect to an ideal design area covering said dielectric layer, of 70% or more.

15. A method of production of an inhibitor particle as set forth in claim 1,
said method of production of an inhibitor particle comprising
a dispersion preparation step of preparing an aqueous dispersion including a core powder forming said core part, a water-soluble metal salt including a metal or alloy forming said covering layer, and a surfactant and
a reduction-precipitation step of mixing said aqueous dispersion and reducing agent and precipitating by reduction a metal or alloy forming said covering layer on an outside surface of said core powder.

16. The method of production of an inhibitor particle as set forth in claim 15, wherein said surfactant is a nonionic surfactant and a hydrophilic-lipophilic balance value is 8 to 20.

17. The method of production of an inhibitor particle as set forth in claim 15, wherein said surfactant is included in an amount, with respect to the water in said aqueous dispersion as 100 parts by weight, of 0.001 to 1 part by weight.

18. A method of production of an inhibitor particle as set forth in claim 1,
said method of production of an inhibitor particle having:
a dispersion preparation step of preparing an aqueous dispersion including a core powder forming said core part, a water-soluble metal salt including a metal or alloy forming said covering layer, and a water-soluble polymer compound and
a reduction-precipitation step of mixing said aqueous dispersion and reducing agent and precipitating by reduction a metal or alloy forming said covering layer on an outside surface of said core powder.

19. The method of production of an inhibitor particle as set forth in claim 18, wherein said water-soluble polymer compound is at least one of an acrylic acid ester polymer, methacrylic acid ester polymer, and copolymer of acrylic acid ester and methacrylic acid ester and said polymer has a molecular weight of 50,000 to 200,000 and an acid value of 3 mgKOH/g to 20 mgKOH/g.

20. The method of production of an inhibitor particle as set forth in claim 18, wherein said water-soluble polymer compound is included in an amount, with respect to the water in said aqueous dispersion as 100 parts by weight, of 0.001 to 1 part by weight.

21. The method of production of an inhibitor particle as set forth in claim 19, wherein said water-soluble polymer compound is a polyvinyl alcohol.

22. The method of production of an inhibitor particle as set forth in claim 15, wherein said reducing agent added is at least one of hydrazine, hypophosphoric acid, and formic acid and is included in an amount, with respect to the water in said aqueous dispersion as 100 parts by weight, of 0.1 to 10 parts by weight.

23. The method of production of an inhibitor particle as set forth in claim 15, further comprising causing a metal or alloy for forming said covering layer to be precipitated by reduction on the outside surface of said core powder, then heat treating said core powder at a heat treatment temperature of 200 to 400° C.

24. The method of production of an inhibitor particle as set forth in claim 15, wherein the content of the water-soluble metal salt in said aqueous dispersion is, with respect to the water as 100 parts by weight, 0.01 to 1 part by weight.

25. The method of production of an inhibitor particle as set forth in claim 15, wherein said water-soluble metal salt is at least one of platinum chloride, rhodium chloride, rhenium pentachloride, rhenium trichloride, and ruthenium chloride.
